(19) United States
(12) Patent Application Publication
(10) Pub. No.: US 2002/0176666 A1
(43) Pub. Date: Nov. 28, 2002

(54) Dispersion compensator

(76) Inventor: Wenhua Lin, Pasadena, CA (US)

Correspondence Address: Travis Dcdd, 2490 Heyneman Hollow, Fallbrook, CA, 92028, US

(21) Appl. No.: 09/866,491

(22) Filed: May 25, 2001

(51) Int. Cl. G02B 6/26

(52) U.S. Cl. 385/39; 385/37

(57) ABSTRACT

A dispersion compensator for changing the dispersion profile of a light signal is disclosed. The dispersion profile of a light signal is the intensity versus time profile of the light signal. The compensator includes a plurality of array waveguides that are each configured to receive a portion of an input light signal having an input dispersion profile. A light distribution component is configured to receive the light signal portions from the array waveguides and to combine the light signal portions so as to form an output light signal with an output dispersion profile. The array waveguides are configured such that the output dispersion profile is different from the input dispersion profile.

### BACKGROUND

1. Field of the Invention

The invention relates to one or more optical networking components. In particular, the invention relates to dispersion compensators.

2. Background of the Invention

Optical networks include optical fibers that carry light signals to a variety of optical components. Each light signal typically includes a distribution of wavelengths. Different wavelengths tend to travel along the optical fibers at different speeds. As a result, the light signal tends to disperse as it travels along the optical fiber. Significant levels of dispersion can affect the performance of an optical network.

For the above reasons, there is a need for optical components that compensate for and/or correct the effects of dispersion.

### SUMMARY OF THE INVENTION

The invention relates to a dispersion compensator for changing the dispersion profile of a light signal. The dispersion profile of a light signal is the intensity versus time profile of the light signal. The compensator includes a plurality of array waveguides that are each configured to receive a portion of an input light signal having an input dispersion profile. A light distribution component is configured to receive the light signal portions from the array waveguides and to combine the light signal portions so as to form an output light signal with an output dispersion profile. The array waveguides are configured such that the output dispersion profile is different from the input dispersion profile.

Another embodiment of the dispersion compensator includes a plurality of array waveguides that are each configured to receive a portion of an input light signal having an input dispersion profile. An output waveguide is configured to receive the light signal portions from the array waveguides. The light signal portions received by the output waveguide are combined into an output light signal having an output dispersion profile. The array waveguides are configured such that the output dispersion profile is different from the input dispersion profile.

The output dispersion profile can be narrower or broader than the input dispersion profile. The output dispersion profile can have positive dispersion slope or negative dispersion slope relative to the input dispersion profile. Additionally, the output dispersion profile can be narrower than the input dispersion profile and have positive dispersion slope or negative dispersion slope relative to the input dispersion profile. Further, the output dispersion profile can be broader than the input dispersion profile and have positive dispersion slope or negative dispersion slope relative to the input dispersion profile.

Different array waveguides can have different lengths. The lengths of the array waveguides can be selected so as to change the output dispersion profile relative to the input dispersion profile.

In one embodiment, the number of array waveguides is equal to N. Each array waveguide is associated with an array waveguide index j where j=1 through N. The length of the array waveguides includes an exponential function with a base that is a function of the array waveguide index. In some instances, the exponential function includes α(j+C)^{α} where C, α and β are constants that are not a function of the array waveguide index.

In some instances, the array waveguides are configured to provide a demultiplexing function in addition to changing the dispersion profile. The demultiplexing function causes the light distribution component to direct output light signals having different wavelengths to different locations on an output side of the light distribution component. Alternatively, the demultiplexing function causes the light distribution component to direct output light signals having different wavelengths to different output waveguides.

The invention also relates to a method of changing the dispersion profile of a light signal. The method includes distributing an input light signal to a plurality of array waveguides such that each array waveguide receives a portion of the input light signal. The input light signal has an input dispersion profile. The method also includes combining the portions of the input light signal from the array waveguides into an output light signal having an output dispersion profile. The output dispersion profile is different from the input dispersion profile.

The light signal portions can be combined such that the output light signal has a dispersion profile that is broader or narrower than the dispersion profile of the input light signal. Alternatively or additionally, the light signal portions can be combined such that the output dispersion profile has positive dispersion slope relative to the input dispersion profile or has negative dispersion slope relative to the input dispersion profile.

### BRIEF DESCRIPTION OF THE FIGURES

FIG. 1A illustrates an embodiment of a dispersion compensator according to the present invention. The dispersion compensator is configured to convert an input light signal having an input dispersion profile into an output light signal having an output dispersion profile.

FIG. 1B illustrates a dispersion compensator having a plurality of input waveguides and a plurality of output waveguides. Each input waveguide is associated with an output waveguide.

FIG. 2A shows the dispersion profile of an input light signal in an input waveguide of the dispersion compensator.

FIG. 2B illustrates the dispersion profile of an output light signal in an output waveguide. The dispersion profile of the output light signal is narrower than the dispersion profile of the input light signal shown in FIG. 2A.

FIG. 2C shows the dispersion profile of an input light signal in an input waveguide of the dispersion compensator.

FIG. 2D illustrates the dispersion profile of an output light signal in an output waveguide. The dispersion profile of the output light signal is broader than the dispersion profile of the input light signal shown in FIG. 2C.

FIG. 2E shows the dispersion profile of an input light signal in an input waveguide of the dispersion compensator.

FIG. 2F illustrates the dispersion profile of an output light signal in an output waveguide. The dispersion profile of the output light signal has positive dispersion slope relative to the dispersion profile of the input light signal shown in FIG. 2E.

FIG. 2G shows the dispersion profile of an input light signal in an input waveguide of the dispersion compensator.

FIG. 2H illustrates the dispersion profile of an output light signal in an output waveguide. The dispersion profile of the output light signal has positive dispersion slope relative to the dispersion profile of the input light signal shown in FIG. 2H.

FIG. 3 illustrates a dispersion compensator configured to provide a demultiplexing function in addition to a dispersion changing function.

FIG. 4A illustrates a dispersion compensator having a single light distribution component.

FIG. 4B illustrates another embodiment of a dispersion compensator having a single light distribution component.

FIG. 5A illustrates a suitable construction for an optical component having a dispersion compensator.

FIG. 5B is a topview of an optical component having a dispersion compensator.

FIG. 5C is a cross section of the component in FIG. 5B taken at any of the lines labeled A.

FIG. 5D illustrates an optical component having a cladding layer positioned over a light transmitting medium.

FIG. 5E illustrates a suitable construction of a reflector for use with a dispersion compensator.

FIG. 6A illustrates an optical component having a base with a light barrier positioned over a substrate.

FIG. 6B illustrates an optical component having a base having a light barrier with a surface positioned between sides. A waveguide is formed over the surface and a light transmitting medium is positioned adjacent to the sides.

FIG. 7A through FIG. 7E illustrate a method for forming a component having a dispersion compensator.

### DETAILED DESCRIPTION OF THE PREFERRED EMBODIMENT

The invention relates to a dispersion compensator for changing the dispersion profile of a light signal. The dispersion profile of a light signal is the intensity versus time profile of the light signal. The compensator includes an input waveguide that carries an input light signal having an input dispersion profile. The compensator also includes a plurality of array waveguides that are each configured to receive a portion of the input light signal. A light distribution component is configured to receive the light signal portions from the array waveguides and to combine the light signal portions so as to form an output light signal with an output dispersion profile. The array waveguides are configured such that the output dispersion profile is different from the input dispersion profile. The output dispersion profile is different from the input dispersion profile in that the change in the output dispersion profile relative to the input dispersion profile is beyond the level that occurs from the variations in fabrication of prior array waveguides.

The array waveguides each have a length. The lengths of the array waveguides can be selected to produce a particular output dispersion profile. For instance, the length of the array waveguides can be selected such that the output dispersion profile is narrower or broader than the input dispersion profile. Alternatively, the length of the array waveguides can be selected such that the output dispersion profile has positive dispersion slope or negative dispersion slope relative to the input dispersion profile. Further, the lengths of the array waveguides can be selected such that the output dispersion profile is narrower than the input dispersion profile and has positive or negative dispersion slope relative to the input dispersion profile. The lengths of the array waveguides can also be selected such that the output dispersion profile is broader than the input dispersion profile and has positive or negative dispersion slope relative to the input dispersion profile.

Because the dispersion profile of the light signals on the output waveguide can be selected, the dispersion compensator can be used to correct for the effects of dispersion on optical networks. For instance, a dispersion compensator configured to convert an input light signal to an output light signal having a narrower intensity versus time profile can be positioned before optical components that require narrow intensity versus time profiles. Alternatively, a dispersion compensator configured to convert an input light signal to an output light signal having a narrower intensity versus time profile can be positioned before long optical fiber runs to compensate for the dispersion that occurs during the optical fiber run.

In some instances, the dispersion compensator is configured to provide a demultiplexing function in addition to changing the dispersion profile. The demultiplexing function causes the light distribution component to direct output light signals having different wavelengths to different output waveguides. Different channels of an optical network are typically carried on light signals having different wavelengths. As a result, a dispersion compensator configured to provide demultiplexing function can cause different channels to appear on different output waveguides with each channel having a desired dispersion profile.

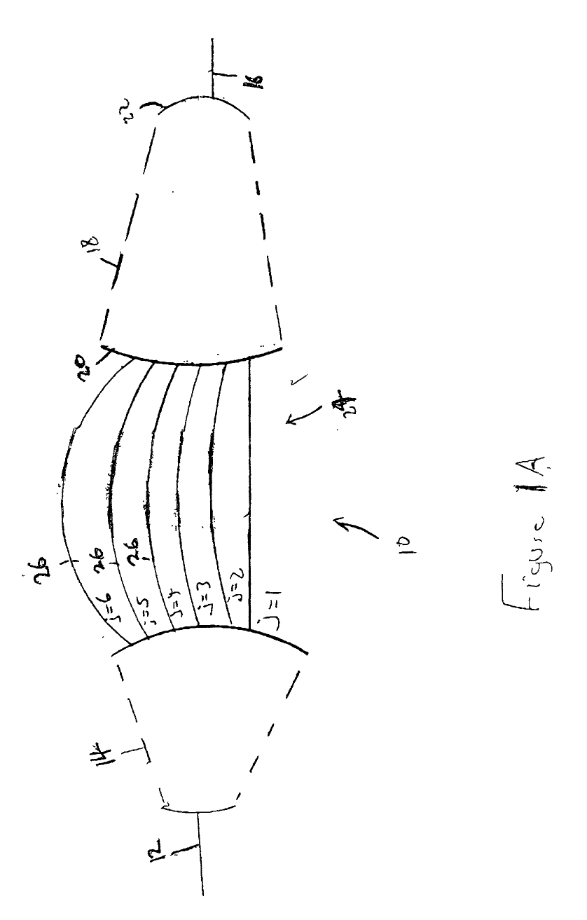

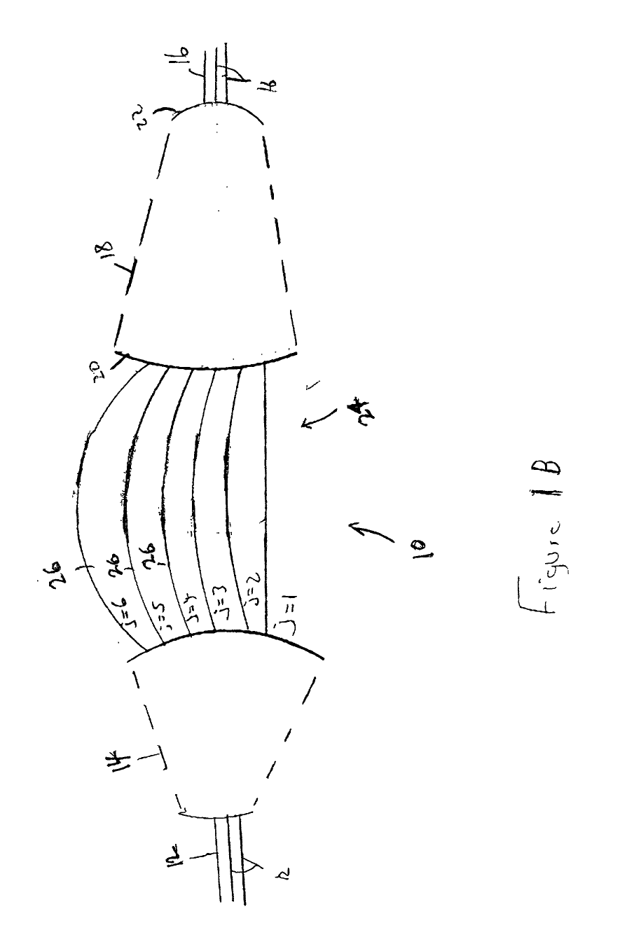

FIG. 1A illustrates an embodiment of a dispersion compensator 10 according to the present invention. The dispersion compensator 10 includes at least one input waveguide 12 in optical communication with an input light distribution component 14 and an output waveguide 16 in optical communication with an output light distribution component 18. The output light distribution component 18 has an input side 20 and an output side 22. A suitable input light distribution component 14 and/or output light distribution component 18 includes, but is not limited to, star couplers, Rowland circles, multi-mode interference devices, mode expanders and slab waveguides. Although a single output waveguide 16 is illustrated, the dispersion compensator 10 can include a plurality of output waveguides 16.

An array waveguide grating 24 connects the input light distribution component 14 and the output light distribution component 18. The array waveguide grating 24 includes a plurality of array waveguides 26 that each have a length. Because the array waveguides 26 are often curved, the length is not consistent across the width of the array waveguide 26. As a result, the length of an array waveguide can refer to the length of an array waveguide 26 averaged across the width of the array waveguide 26. Further, the length of an array waveguide can refer to the effective length of the array waveguide 26. Although six array waveguides 26 are illustrated, dispersion compensators 10 typically include many more than six array waveguides 26 and fewer are possible. Increasing the number of array waveguides 26 can increase the degree of resolution provided by the array waveguide grating.

During operation of the dispersion compensator 10, an input light signal enters the input light distribution component 14 from the input waveguide 12. The input light distribution component 14 distributes the light signal to the array waveguides 26. Each array waveguide 26 receives a portion of the input light signal. Each array waveguide 26 carries the received light signal portion to the output light distribution component 18.

The light signal portions entering the output light distribution component 18 from each of the array waveguides 26 combine to form an output light signal. The output light distribution component 18 is constructed to converge the output light signal at a location on the output side 22 of the output light distribution component 18. The output waveguide 16 is positioned at the location on the output side 22 where the light signal is converged. Accordingly, the output waveguide 16 receives the output light signal.

The input light signal can include one channel or more than one channel. When the input light signal has more than one channel, the output light signal also has more than one channel. As a result, the dispersion compensator can compensate for dispersion in a plurality of channels.

Although FIG. 1A illustrates a dispersion compensator 10 having a single input waveguide 12 and a single output waveguide 16, the dispersion compensator 10 can have a plurality of input waveguides 12 and a plurality of output waveguides 16 as shown in FIG. 1B. Each input waveguide 12 is associated with an output waveguide 16 in that the input light signals on a particular input waveguide are converted to output light signals that appear on a particular output waveguide 16. As a result, the dispersion compensator 10 can be placed along more than one optical fiber. For instance, the dispersion compensator 10 of FIG. 1B can be used with three optical fibers.

The length of the array waveguides 26 can have constant component, Lo, and one or more variable components, L(j). The constant component, Lo, can be a length that is the same for each array waveguide 26 and can be equal to zero.

The variable component, L(j), is a function of a particular array waveguide 26. For instance, the array waveguides 26 can each be associated with an array waveguide index, j. When the array waveguide grating 24 includes j=1 . . . N array waveguides 26, the value of the variable component, L(j), is a function of the array waveguide index, j. FIG. 1A illustrates an array waveguide grating 24 with N=6 array waveguides 26. Each of the j=1 through j=6 array waveguides 26 are labeled. The length of each array waveguide 26 is L=Lo+L(j).

The variable component, L(j), can include a dispersion changing function, L_{DC}(j), that causes the output light signal to have a different dispersion profile than the input light signal. A suitable dispersion changing function, L_{DC}(j), includes, but is not limited to, an exponential function with a base that is a function of the array waveguide index j. The exponential function causes the dispersion profile of the input light signal to be different from the dispersion profile of the output light signal. Equation 1 is an example of a suitable exponential function where f(j) indicates some function of the array waveguide index j. Additionally, β and α are constants for each of the array waveguides 26 and are both non zero.

L(j)=L_{DC}(j)=β(f(j))^{α} (1)

A suitable f(j) includes, but is not limited to, j+C as shown in Equation 2. The C is a constant value for each array waveguide 26 or can be zero.

L(j)=L_{DC}(j)=β(j+C)^{α} (2)

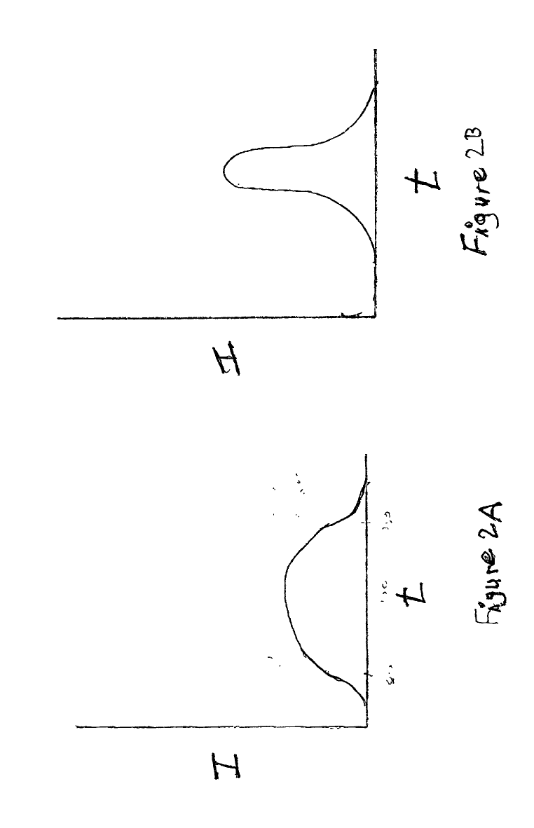

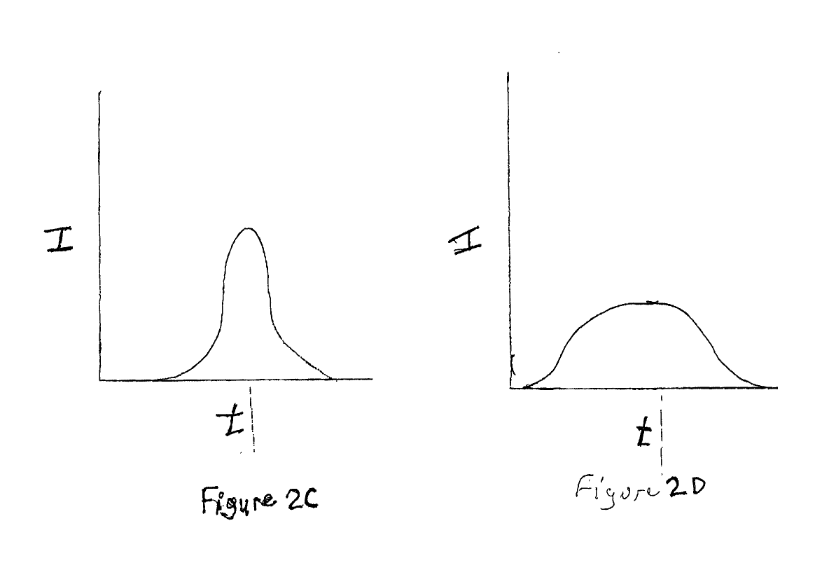

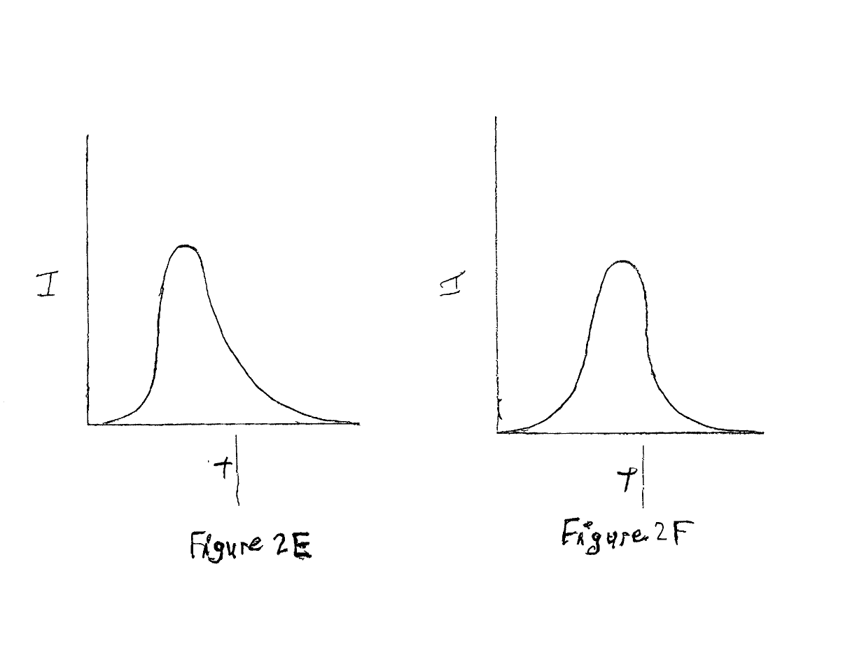

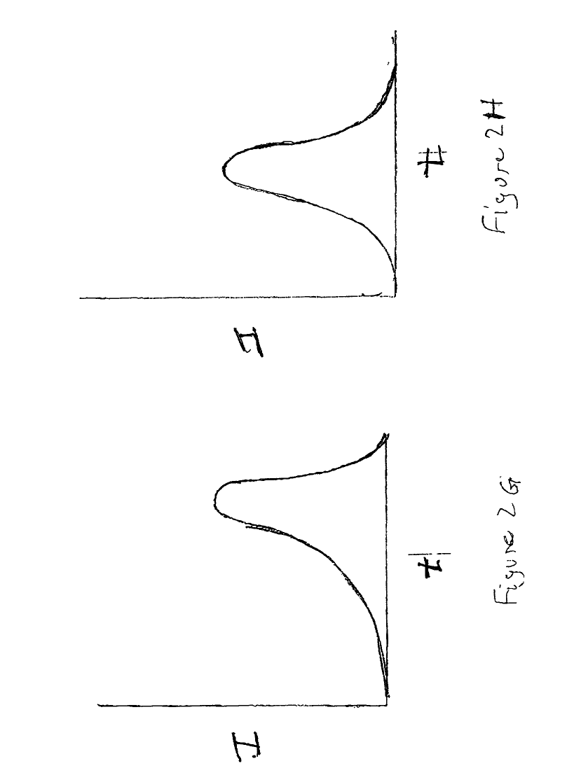

When α is equal to 2 and β is negative, the dispersion profile narrows as shown in FIG. 2A and FIG. 2B. FIG. 2A shows the dispersion profile of the input light signal and FIG. 2B shows the dispersion profile of the output light signal. The dispersion profile of the output light signal is narrower than the dispersion profile of the input light signal. Accordingly, the array waveguide grating 24 causes the input light signal to undergo negative dispersion. This negative dispersion change can be generated from the phase 2*π*n_{c}*L_{DC}/λ where n_{c} is effective refractive index of the waveguide. The degree of dispersion change increases as the magnitude of β increases. Accordingly, β can be made more negative when a narrower dispersion profile is desired.

When α is equal to 2 and β is positive, the dispersion profile broadens as shown in FIG. 2C and FIG. 2D. FIG. 2C shows the dispersion profile of the input light signal and FIG. 2D shows the dispersion profile of the output light signal. The dispersion profile of the output light signal is broader than the dispersion profile of the input light signal. Accordingly, the array waveguide grating 24 causes the input light signal to undergo positive dispersion. This positive dispersion can be generated from the phase 2*π*n_{c}*L_{DC}/λ. The degree of dispersion change increases as the magnitude of β increases. Accordingly, β can be made more positive when a broader dispersion profile is desired.

Other values of α and β can be used to change other features of the dispersion profile. For instance, when α is greater than 2 and β is positive, positive dispersion slope results as shown in FIG. 2E and FIG. 2F. FIG. 2E shows the dispersion profile in the input waveguide 12 and FIG. 2F shows the dispersion profile in the output waveguide 16. The array waveguide grating 24 causes the output dispersion profile to shift toward longer times as compared to the input light signal. This shift is caused by the dispersion slope. When α is greater than 2 and β is positive, positive dispersion slope results. The degree of dispersion slope change increases as the magnitude of β increases. Accordingly, β can be made more positive when a more positive dispersion slope is desired. As illustrated, positive dispersion slope can be used to provide a more symmetrical signal in the output.

When α is greater than 2 and β is negative, negative dispersion slope results as shown in FIG. 2G and FIG. 2H. FIG. 2G shows the dispersion profile in the input waveguide 12 and FIG. 2H shows the dispersion profile in the output waveguide 16. The array waveguide grating 24 causes the output dispersion profile to shift more toward shorter times than the input light signal. The degree of dispersion slope change increases as the magnitude of β increases. Accordingly, β can be made more negative when a more negative dispersion slope is desired. As illustrated, negative dispersion slope can be used to provide a more symmetrical signal in the output.

When α is increased to three or higher the dispersion compensator can compensate for higher order dispersion. In other words, the dispersion compensator 10 has the ability to compensate an arbitrary dispersion response using higher order dispersion changing functions.

A suitable C for use in equation 2 includes, but is not limited to, a function of N. A suitable function of N includes, but is not limited to, −(N+1)/2 as shown in Equation 3 and −N/2. When C is −(N+1)/2, the exponential function is centered relative to the array waveguides 26. More specifically, the array waveguide(s) 26 having the smallest value of L(j) is the (N+1)/2 th array waveguide when the number of array waveguides 26 is odd and is the N/2−0.5 th and N/2+0.5 th array waveguides 26 when the number of array waveguides 26 is even. The exponential function need not be centered relative to the array waveguides 26 in order for the dispersion compensator 10 to operate. For instance, C can be equal to zero.

L(j)=L_{DC}(j)=β(j−(N+1)/2)^{α} (3)

The effects of the variable component, L(j), are additive. As a result, the length of the array waveguides 26 can include more than one variable component, L(j). For instance, the array waveguide grating 24 can be designed so as to produce negative dispersion and positive dispersion slope. As a result, the dispersion profile on the output waveguide 16 would be narrower and more shifted toward the longer times than the dispersion profile on the input waveguide 12. Other combinations include, but are not limited to, negative dispersion and negative dispersion slope; positive dispersion and positive dispersion slope or positive dispersion and negative dispersion slope.

Equation 4 shows an equation for the length of array waveguides 26 having more than one variable component, L(j).

L=Lo+L_{DC}(j)+L′_{DC}(j)=Lo+β(j−N/2)^{α}+β′(j−N/2)^{α′} (4)

The value of α, α′, β and β′ are selected so as to achieve the desired combination of variable component effects. For instance, when it is desired to produce a dispersion compensator 10 having negative dispersion and positive dispersion slope, the value of α is 2, β is negative in order to provide the negative dispersion and α′ is greater than 2 and β′ is positive in order to provide the positive dispersion slope. The values of βand β′ are often less than one.

The variable component, L(j), can include a demultiplexing function, L_{D}(j), in addition to a dispersion changing function, L_{DC}(j). When different channels are carried on light signals having different wavelengths, the demultiplexing function, L_{D}(j), causes the light distribution component to direct different channels to different locations on the output side 22 of the light distribution component. A suitable demultiplexing function, L_{D}(j), includes, but is not limited to, L_{D}(j)=jΔL or (j−1)ΔL where ΔL is a constant.

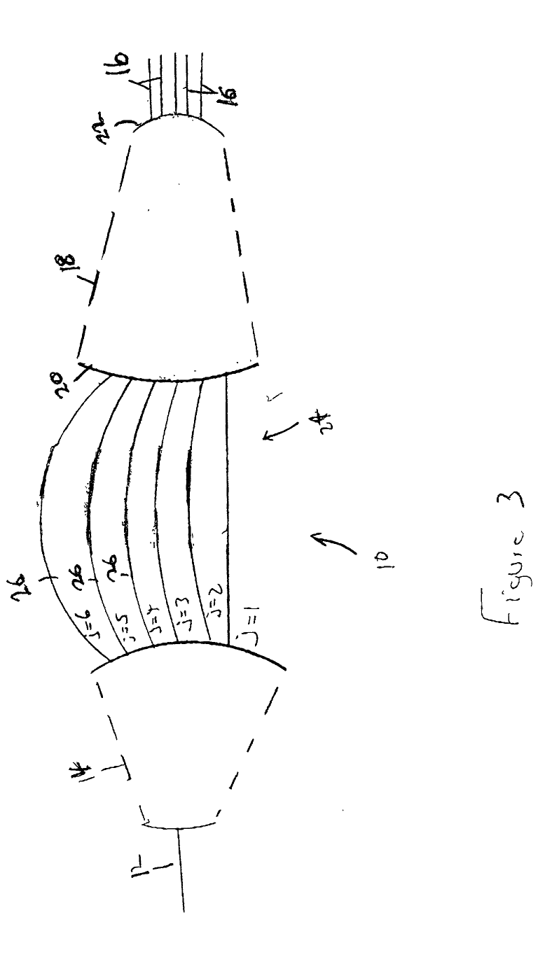

FIG. 3 illustrates an example of a dispersion compensator 10 configured to provide a demultiplexing function, L_{D}(j). The dispersion compensator 10 includes a plurality of output waveguides 16 positioned at locations along the output side 22 of the light distribution component. The output waveguides 16 are each positioned to receive a particular one of the channels. Accordingly, each output waveguide 16 carries a particular channel. Alternatively, all or a portion of the output waveguides can be positioned to receive a band of the channels. For instance, one or more of the output waveguides can be configured to receive two or more of the channels that are adjacent to one another in the wavelength spectrum. Output waveguides configured to receive more than one channel are associated with a band of channels. The dispersion compensator changes the dispersion of each channel in a band of channels carried on an output waveguide.

Although FIG. 3 illustrates a single input waveguide 12, the dispersion compensator 10 can include a plurality of input waveguides 12.

In order to simplify describing operation of a dispersion compensator 10 having a demultiplexing function, L_{D}(j), it is presumed that the variable component, L(j) is equal to the demultiplexing function, L_{D}(j). During operation of the dispersion compensator 10 so as to provide a demultiplexing function, L_{D}(j), each array waveguide 26 carries the received light signal portion to the output light distribution component 18. A light signal portion traveling through a long array waveguide 26 will take longer to enter the output light distribution component 18 than a light signal portion light traveling through a shorter array waveguide 26. Unless the length differential, ΔL, between adjacent array waveguide 26 is a multiple of the light wavelength, the light signal portion traveling through a long array waveguide 26 enters the output light distribution component 18 in a different phase than the light signal portion traveling along the shorter array waveguide 26.

The light signal portion entering the output light distribution component 18 from each of the array waveguides 26 combines to form the output light signal. Because the array waveguide 26 causes a phase differential between the light signal portions entering the output light distribution component 18 from adjacent array waveguides 26, the output light signal is diffracted at an angle labeled, θ. The output light distribution component 18 is constructed to converge the output light signal at a location on the output side 22 of the output light distribution component 18. The location where the output light signal is incident on the output side 22 of the output light distribution component 18 is a function of the diffraction angle, θ. As illustrated in FIG. 3, the phase differential causes the output light signal to be converged at the output waveguide 16 labeled A. As a result, the output light signal appears on the output waveguide 16 labeled A.

Because ΔL is a different portion of the wavelength for each channel, the amount of the phase differential is different for different channels. As a result, different channels are diffracted at different angles and are accordingly converged at different locations on the output side 22. Hence, when a multichannel beam enters the output light distribution component 18, each of the different channels is converged at a different location on the output side 22. The output waveguides 16 are positioned at each location on the output side 22 where a channel is converged. As a result, each output waveguide 16 carries a different channel.

The demultiplexing function, L_{D}(j), is additive with the one or more dispersion changing functions, L_{DC}(j). As a result, the variable component, L(j), can include both a dispersion changing function, L_{DC}(j), and a demultiplexing function, L_{D}(j). When the array waveguide grating 24 is configured to have both a demultiplexing function, L_{D}(j), and a dispersion changing function, L_{DC}(j), the output light signal associated with each channel exhibits the effects of the dispersion changing function, L_{DC}(j). For instance, when the dispersion changing function, L_{DC}(j), provides a narrowing of the dispersion profile, each of the output light signals on an output waveguide 16 has a narrower dispersion profile than the associated input light signal had on the input waveguide 12. Accordingly, the dispersion compensator 10 can concurrently provide dispersion changing functions, L_{DC}(j), and a demultiplexing function, L_{D}(j).

The dispersion changing function, L_{DC}(j), does have some affect on the bandwidth of the demultiplexing function. However, the amount of change to the bandwidth can often be designed out or is often negligible.

Equation 5 shows an equation for the length of array waveguides 26 for an array waveguide grating 24 having both a demultiplexing function, L_{D}(j), and a dispersion changing function, L_{DC}(j). The value of ΔL, α and β are selected so as to achieve the desired combination of demultiplexing and dispersion. For instance, when it is desired to produce demultiplexing and negative dispersion, ΔL is not equal to zero, the value of α is 2 and β is negative.

L=Lo+L_{D}(j)+L_{DC}(j)=Lo+jΔL+β(j+C)^{α} (5)

As noted above, the dispersion changing functions, L_{DC}(j), are additive. As a result, Equation 5 can include two or more dispersion changing functions, L_{DC}(j), as shown in Equation 6.

L=Lo+L_{D}(j)+L_{DC}(j)+L′_{DC}(j) (6)

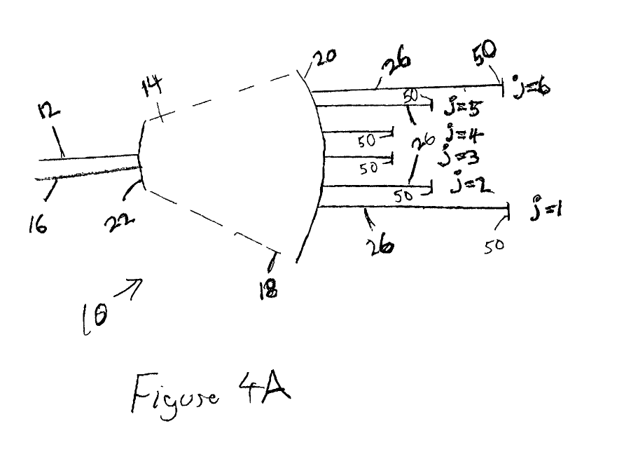

Each of the dispersion compensators shown in FIG. 1A, FIG. 1B and FIG. 3 can be constructed with a single light distribution component by positioning reflectors 50 along the array waveguides 26 as shown in FIG. 4A. The dispersion compensator 10 includes an input waveguide 12 and an output waveguide 16 that are each connected to the output side 22 of the input light distribution component 14. The array waveguides 26 include a reflector 50 configured to reflect light signal portions back toward the light distribution component.

During operation of the dispersion compensator 10, an input light signal from the input waveguide 12 is distributed to the array waveguides 26. The array waveguides 26 carry the light signal portions to the reflector 50 where they are reflected back toward the light distribution component. The light distribution component combines the light signal portions into the output light signal and converges the output light signal at the output waveguide 16. As a result, the output waveguide 16 carries the output light signal.

The dispersion compensator 10 of FIG. 4A has array waveguides 26 with lengths selected as described above. However, the light signal portions travel through each array waveguide 26 twice. As a result, the effective length of each array waveguide 26 is twice the actual length. Accordingly, the length of the array waveguides 26 of FIG. 4A can be half the length of the array waveguides 26 of FIG. 1A while still providing the same degree of dispersion change.

FIG. 4B illustrates another embodiment of a dispersion compensator having a single light distribution component and curved array waveguides 26. The dispersion compensator is included on an optical component 36. The edge of the optical component 36 is shown as a dashed line. The edge of the optical component can include one or more reflective coatings positioned so as to serve as reflector(s) 50 that reflect light signals from the array waveguides back into the array waveguides. Alternatively, the edge of the optical component can be smooth enough to act as a mirror that reflects light signals from the array waveguide back into the array waveguide. An optical component having a dispersion compensator according to FIG. 4B can be fabricated by making an optical component having a dispersion compensator 10 according to FIG. 1A, FIG. 1B or FIG. 3 and cleaving the optical component 36 down the center of the array waveguides. When the optical component 36 was symmetrical about the cleavage line, two optical components can result. Because, the light signal must travel through each array waveguide twice, each resulting dispersion compensators will provide about the same dispersion compensation as would have been achieved before the optical component 36 was cleaved.

Although the dispersion compensator 10 of FIG. 4A and FIG. 4B are shown with a single input waveguide 12 and a single output waveguide, the dispersion compensator 10 can include a plurality of input waveguides 12 and/or a plurality of output waveguides. Accordingly, the dispersion compensators 10 of FIG. 4A and FIG. 4B can also be adapted to provide demultiplexing functions in addition to dispersion compensation.

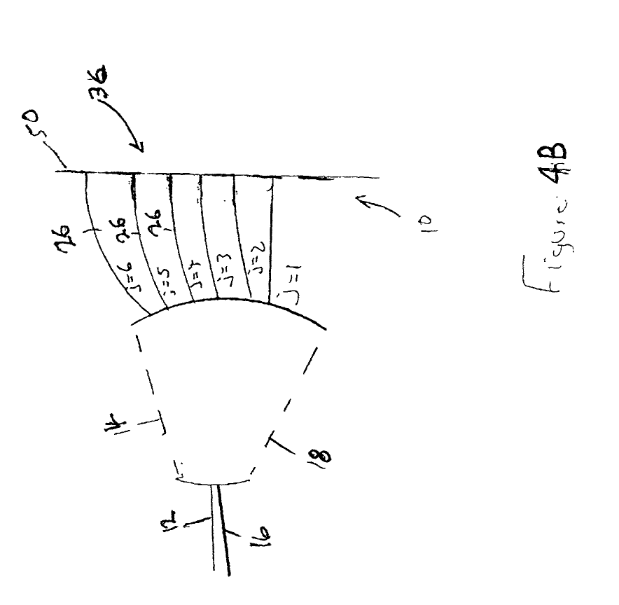

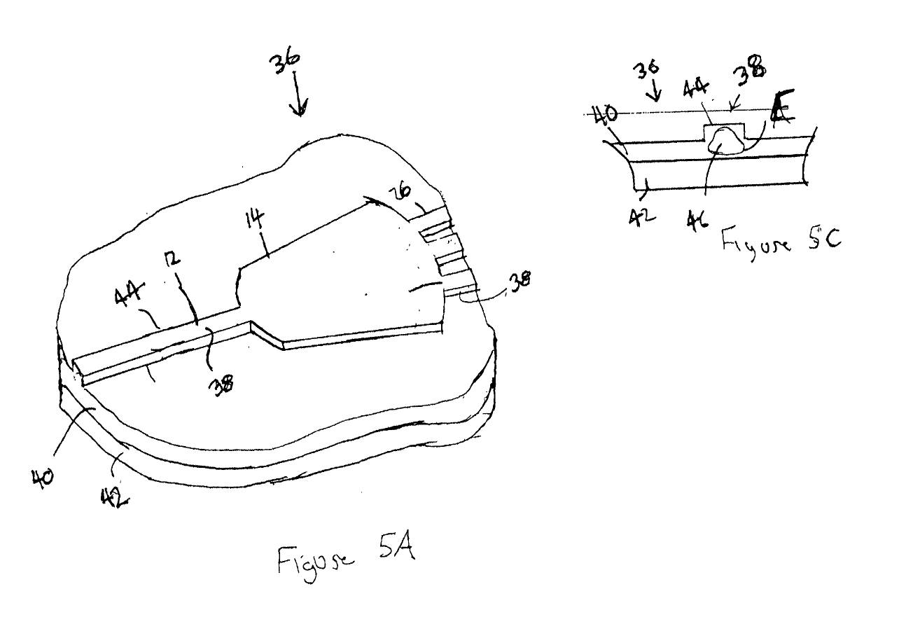

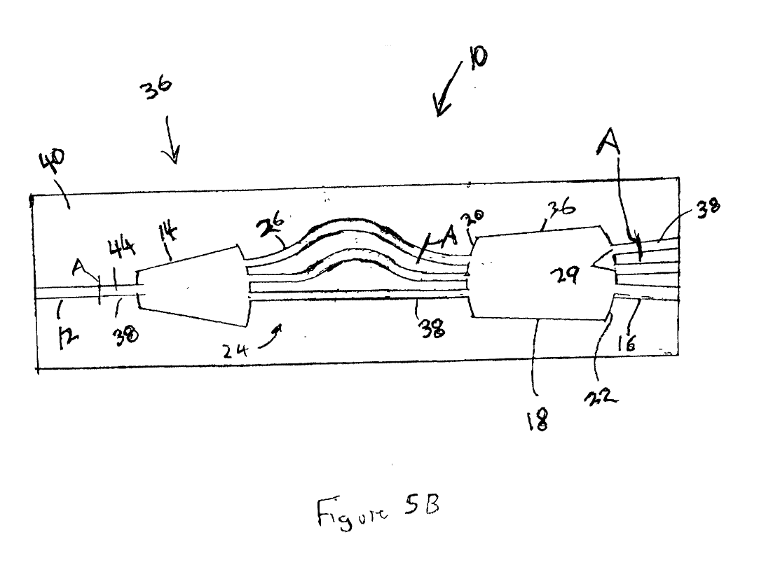

FIG. 5A illustrates a suitable construction for an optical component 36 having a dispersion compensator 10 according to the present invention. A portion of the dispersion compensator 10 is shown on the component 36. The illustrated portion has an input light distribution component 14, an input waveguide 12 and a plurality of array waveguides 26. FIG. 5B is a topview of an optical component 36 having a dispersion compensator 10 constructed according to FIG. 1A. FIG. 5C is a cross section of the component 36 in FIG. 5B taken at any of the lines labeled A. Accordingly, the waveguide 38 illustrated in FIG. 5C could be the cross section of an input waveguide 12, an array waveguide 26 or an output waveguide 16.

For purposes of illustration, the dispersion compensator 10 is illustrated as having three array waveguides 26 and an output waveguide 16. However, array waveguide 26 gratings 24 for use with a dispersion compensator 10 can have many more than three array waveguides 26. For instance, array waveguide 26 gratings 24 can have tens to hundreds or more array waveguides 26.

The component 36 includes a light transmitting medium 40 formed over a base 42. The light transmitting medium 40 includes a ridge 44 that defines a portion of the light signal carrying region 46 of a waveguide 38. Suitable light transmitting media include, but are not limited to, silicon, polymers, silica, GaAs, InP and LiNbO₃. As will be described in more detail below, the base 42 reflects light signals from the light signal carrying region 46 back into the light signal carrying region 46. As a result, the base 42 also defines a portion of the light signal carrying region 46. The line labeled E illustrates the mode profile of a light signal carried in the light signal carrying region 46 of FIG. 5C. The light signal carrying region 46 extends longitudinally through the input waveguide 12, the input light distribution component 14, each the array waveguides 26, the output light distribution component 18 and each of the output waveguides 16.

A cladding layer 48 can be optionally be positioned over the light transmitting medium 40 as shown in FIG. 5D. The cladding layer 48 can have an index of refraction less than the index of refraction of the light transmitting medium 40 so light signals from the light transmitting medium 40 are reflected back into the light transmitting medium 40. Because the cladding layer 48 is optional, the cladding layer 48 is shown in some of the following illustrations and not shown in others.

FIG. 5E illustrates a suitable construction of a reflector 50 for use with a dispersion compensator 10 such as the dispersion compensator of FIG. 4. The reflector 50 includes a reflecting surface 52 positioned at an end of an array waveguide 26. The reflecting surface 52 is configured to reflect light signals from an array waveguide 26 back into the array waveguide 26. The reflecting surface 52 extends below the base of the ridge 44. For instance, the reflecting surface 52 can extend through the light transmitting medium 40 to the base 42 and in some instances can extend into the base 42. The reflecting surface 52 extends to the base 42 because the light signal carrying region 46 is positioned in the ridge 44 as well as below the ridge 44 as shown in FIG. 5E. As result, extending the reflecting surface 52 below the base 42 of the ridge 44 increases the portion of the light signal that is reflected.

The array waveguides 26 of FIG. 5B are shown as having a curved shape. A suitable curved waveguide 38 is taught in U.S. patent application Ser. No. 09/756,498, filed on Jan. 8, 2001, entitled “An Efficient Curved Waveguide” and incorporated herein in its entirety. Other dispersion compensator 10 constructions can also be employed. For instance, the principles of the invention can be applied to array waveguide 26 gratings 24 having straight array waveguides 26. Array waveguide 26 gratings 24 having straight array waveguides 26 are taught in U.S. patent application Ser. No. 09/724,175, filed on Nov. 28, 2000, entitled “A Compact Integrated Optics Based Arrayed Waveguide Demultiplexer” and incorporated herein in its entirety.

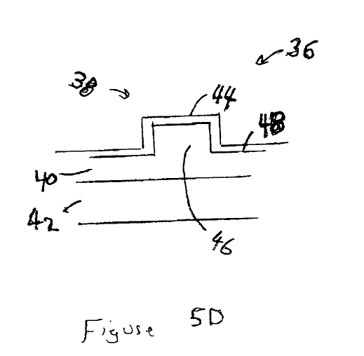

The base 42 can have a variety of constructions. FIG. 6A illustrates a component 36 having a base 42 with a light barrier 80 positioned over a substrate 82. The light barrier 80 serves to reflect the light signals from the light signal carrying region 46 back into the light signal carrying region 46. Suitable light barriers 80 include material having reflective properties such as metals. Alternatively, the light barrier 80 can be a material with a different index of refraction than the light transmitting medium 40. The change in the index of refraction can cause the reflection of light from the light signal carrying region 46 back into the light signal carrying region 46. A suitable light barrier 80 would be silica when the light carrying medium and the substrate 82 are silicon. Another suitable light barrier 80 would be air or another gas when the light carrying medium is silica and the substrate 82 is silicon. A suitable substrate 82 includes, but is not limited to, a silicon substrate 82.

The light barrier 80 need not extend over the entire substrate 82 as shown in FIG. 6B. For instance, the light barrier 80 can be an air filled pocket formed in the substrate 82. The pocket 84 can extend alongside the light signal carrying region 46 so as to define a portion of the light signal carrying region 46.

In some instances, the light signal carrying region 46 is adjacent to a surface 86 of the light barrier 80 and the light transmitting medium 40 is positioned adjacent to at least one side 88 of the light barrier 80. As a result, light signals that exit the light signal carrying region 46 can be drained from the waveguide 38 as shown by the arrow labeled A. These light signals are less likely to enter adjacent array waveguide 26. Accordingly, these light signals are not a significant source of cross talk.

The drain effect can also be achieved by placing a second light transmitting medium 90 adjacent to the sides 88 of the light barrier 80 as indicated by the region below the level of the top dashed line or by the region located between the dashed lines. The drain effect is best achieved when the second light transmitting medium 90 has an index of refraction that is greater than or substantially equal to the index of refraction of the light transmitting medium 40 positioned over the base 42. In some instances, the bottom of the substrate 82 can include an anti reflective coating that allows the light signals that are drained from a waveguide 38 to exit the component 36.

The input waveguide 12, the array waveguides 26 and/or the output waveguide 16 can be formed over a light barrier 80 having sides 88 adjacent to a second light transmitting medium 90.

The drain effect can play an important role in improving the performance of the dispersion compensator 10 because the array waveguide grating 24 includes a large number of waveguides 38 formed in close proximity to one another. The proximity of the waveguides 38 tends to increase the portion of light signals that act as a source of cross talk by exiting one waveguide 38 and entering another. The drain effect can reduce this source of cross talk.

Other base 42 and component 36 constructions suitable for use with a dispersion compensator 10 according to the present invention are discussed in U.S. patent application Ser. No. 09/686,733, filed on Oct. 10, 2000, entitled “Waveguide Having a Light Drain” and U.S. patent application Ser. No. (not yet assigned), filed on Feb. 15, 2001, entitled “Component Having Reduced Cross Talk” each of which is incorporated herein in its entirety.

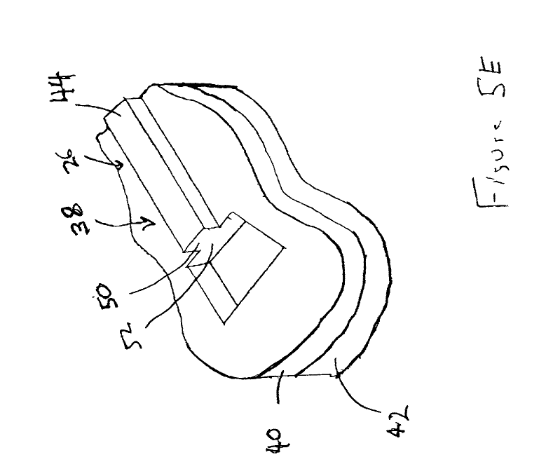

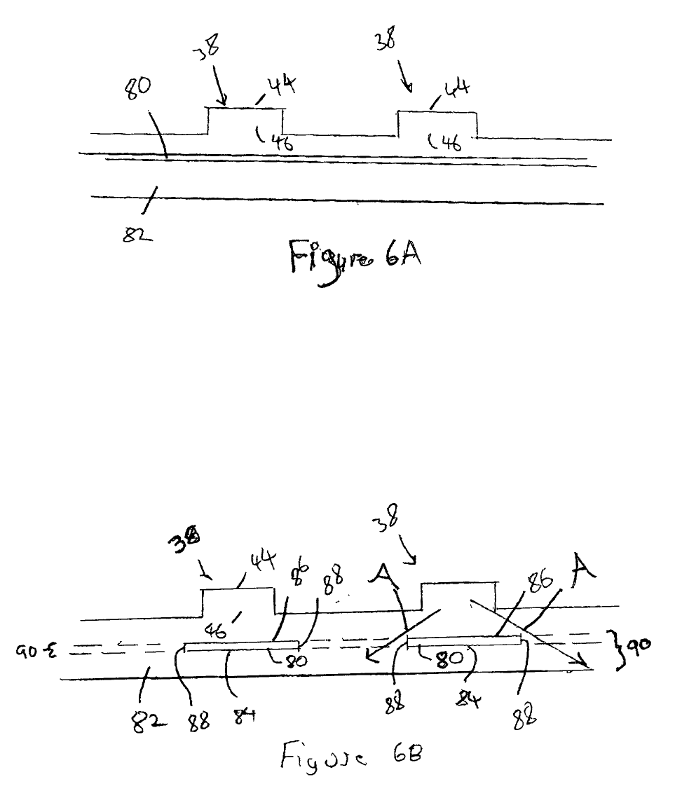

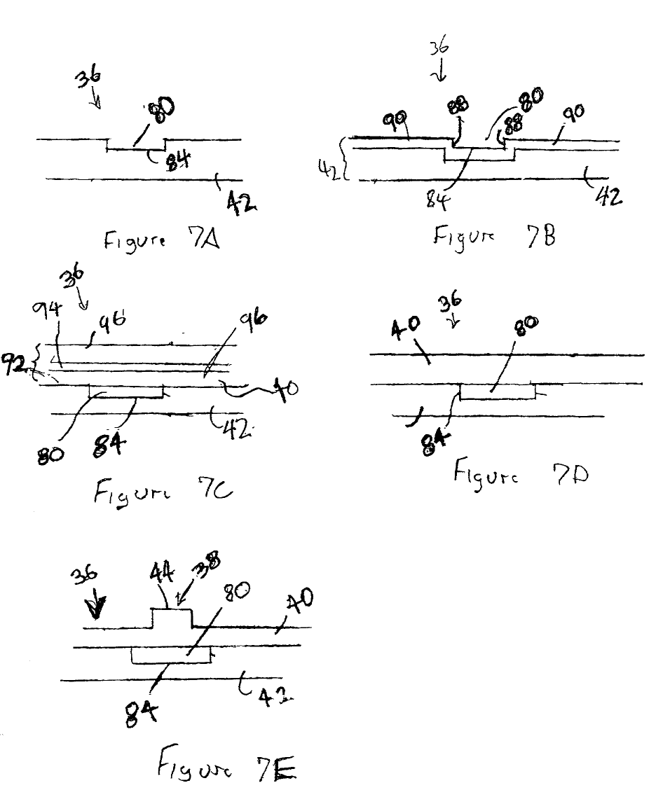

FIG. 7A to FIG. 7E illustrate a method for forming a component 36 having a dispersion compensator 10. A mask is formed on a base 42 so the portions of the base 42 where a light barrier 80 is to be formed remain exposed. A suitable base 42 includes, but is not limited to, a silicon substrate. An etch is performed on the masked base 42 to form pockets 84 in the base 42. The pockets 84 are generally formed to the desired thickness of the light barrier 80.

Air can be left in the pockets 84 to serve as the light barrier 80. Alternatively, a light barrier 80 material such as silica or a low K material can be grown or deposited in the pockets 84. The mask is then removed to provide the component 36 illustrated in FIG. 7A.

When air is left in the pocket 84, a second light transmitting medium 90 can optionally be deposited or grown over the base 42 as illustrated in FIG. 7B. When air will remain in the pocket 84 to serve as the light barrier 80, the second light transmitting medium 90 is deposited so the second light transmitting medium 90 is positioned adjacent to the sides 88 of the light barrier 80. Alternatively, a light barrier 80 material such as silica can optionally be deposited in the pocket 84 after the second light transmitting medium 90 is deposited or grown.

The remainder of the method is disclosed presuming that the second light transmitting medium 90 is not deposited or grown in the pocket 84 and that air will remain in the pocket 84 to serve as the light barrier 80. A light transmitting medium 40 is formed over the base 42. A suitable technique for forming the light transmitting medium 40 over the base 42 includes, but is not limited to, employing wafer bonding techniques to bond the light transmitting medium 40 to the base 42. A suitable wafer for bonding to the base 42 includes, but is not limited to, a silicon wafer or a silicon on insulator wafer 92.

A silicon on insulator wafer 92 includes a silica layer 94 positioned between silicon layers 96 as shown in FIG. 7C. The top silicon layer 96 and the silica layer 94 can be removed to provide the component 36 shown in FIG. 7D. Suitable methods for removing the top silicon layer 96 and the silica layer 94 include, but are not limited to, etching and polishing. The bottom silicon layer 96 remains as the light transmitting medium 40 where the waveguides 38 will be formed. When a silicon wafer is bonded to the base 42, the silicon wafer will serve as the light transmitting medium 40. A portion of the silicon layer 96 can be removed from the top and moving toward the base 42 in order to obtain a light transmitting medium 40 with the desired thickness.

A silicon on insulator wafer can be substituted for the component illustrated in FIG. 7D. The silicon on insulator wafer preferably has a top silicon layer with a thickness that matches the desired thickness of the light transmitting medium 40. The remainder of the method is performed using the silicon on insulator wafer in order to create an optical component 36 having the base 42 shown in FIG. 6A.

The light transmitting medium 40 is masked such that places where a ridge 44 is to be formed are protected. The component 36 is then etched to a depth that provides the component 36 with ridges 44 of the desired height as shown in FIG. 7E.

When the component 36 will include a cladding 48, the cladding 48 can be formed at different places in the method. For instance, the cladding 48 can be deposited or grown on the component 36 of FIG. 7E.

The etch(es) employed in the method described above can result in formation of a facet and/or in formation of the sides of a ridge of a waveguide. These surfaces are preferably smooth in order to reduce optical losses. Suitable etches for forming these surfaces include, but are not limited to, reactive ion etches, the Bosch process and the methods taught in U.S. patent application Ser. No. (not yet assigned); filed on Oct. 16, 2000; and entitled “Formation of a Smooth Vertical Surface on an Optical component 36” which is incorporated herein in its entirety.

As noted above, the dispersion compensator 10 can be constructed such that the array waveguides 26 include a reflector 50. A suitable method for forming a reflector 50 is taught in U.S. patent application Ser. No. 09/723,757, filed on Nov. 28, 2000, entitled “Formation of a Reflecting surface 52 on an Optical component 36” and incorporated herein in its entirety.

Although the dispersion compensator is disclosed in the context of optical components having ridge waveguides, the principles of the present invention can be applied to optical components having other waveguide types. Suitable waveguide types include, but are not limited to, buried channel waveguides and strip waveguide.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A dispersion compensator, comprising:
a plurality of array waveguides that are each configured to receive a portion of an input light signal having an input dispersion profile; and
a light distribution component configured to receive the light signal portions from the array waveguides and to combine the light signal portions so as to form an output light signal with an output dispersion profile, the array waveguides configured such that the output dispersion profile is different from the input dispersion profile.

2. The compensator of claim 1, wherein the array waveguides are configured such that the output dispersion profile is narrower than the input dispersion profile.

3. The compensator of claim 1, wherein the array waveguides are configured such that the output dispersion profile is broader than the input dispersion profile.

4. The compensator of claim 1, wherein the array waveguides are configured such that the output dispersion profile has positive dispersion slope relative to the input dispersion profile.

5. The compensator of claim 1, wherein the array waveguides are configured such that the output dispersion profile has negative dispersion slope relative to the input dispersion profile.

6. The compensator of claim 1, wherein each array waveguide has a length and the lengths of the array waveguides are selected such that the output dispersion profile is different from the input dispersion profile.

7. The compensator of claim 6, wherein the number of array waveguides is equal to N and the array waveguides are associated with an array waveguide index j where j=1 through N, and the lengths of the array waveguides include one or more exponential functions having a base that is a function of the array waveguide index j.

8. The compensator of claim 7, wherein the exponential function includes β(j+C)^{α}, C, α and β each having a constant value for each array waveguide.

9. The compensator of claim 8, wherein α is about 2.

10. The compensator of claim 8, wherein β is positive.

11. The compensator of claim 8, wherein β is negative.

12. The compensator of claim 8, wherein α is greater than 2.

13. The compensator of claim 7, wherein the lengths of the array waveguides include more than one exponential function of the array waveguide index.

14. The compensator of claim 7, wherein the lengths of the array waveguides include a demultiplexing function, the demultiplexing function causing the light distribution component to direct input light signals having different wavelengths to different locations on an output side of the light distribution component.

15. The compensator of claim 14, wherein the demultiplexing function includes a linear function of the array waveguide index.

16. The compensator of claim 14, wherein the linear function includes jΔL where ΔL is a constant for each array waveguide.

17. The compensator of claim 1, wherein the array waveguides are configured such that the light distribution component directs input light signals having different wavelengths to different locations on an output side of the light distribution component.

18. A dispersion compensator, comprising:
an array waveguide grating including a plurality of array waveguides that are each configured to receive a portion of an input light signal having an input dispersion profile; and
an output waveguide configured to receive the light signal portions from the array waveguide grating, the received light signal portions being combined into an output light signal having an output dispersion profile, the array waveguides configured such that the output dispersion profile is different from the input dispersion profile.

19. The compensator of claim 18, wherein the array waveguides are configured such that the output dispersion profile is narrower than the input dispersion profile.

20. The compensator of claim 18, wherein the array waveguides are configured such that the output dispersion profile is broader than the input dispersion profile.

21. The compensator of claim 18, wherein the array waveguides are configured such that the output light signal has positive dispersion slope relative to the input dispersion profile.

22. The compensator of claim 18, wherein the array waveguides are configured such that the output dispersion profile has negative dispersion slope relative to the input dispersion profile.

23. The compensator of claim 18, wherein each array waveguide has a length and the lengths of the array waveguides are selected such that the output dispersion profile is different from the input dispersion profile.

24. The compensator of claim 23, wherein the number of array waveguides is equal to N and the array waveguides are associated with an array waveguide index j where j=1 through N, and the length of the array waveguides includes an exponential function with a base that is a function of the array waveguide index j.

25. The compensator of claim 23, wherein the exponential function includes β(j+C)^{α}, C, α and β each having the same value for each array waveguide.

26. The compensator of claim 23, wherein the output waveguide is one of a plurality of output waveguides and the lengths of the array waveguides include a demultiplexing function, the demultiplexing function causing the light distribution component to direct output light signals having different wavelengths to different output waveguides.

27. The compensator of claim 26, wherein the demultiplexing function includes a linear function of the array waveguide index.

28. A method of changing the dispersion profile of a light signal, comprising:
distributing an input light signal to a plurality of array waveguides such that one or more of the array waveguides receive a portion of the input light signal, the input light signal having an input dispersion profile; and
combining the portions of the input light signal from the array waveguides into an output light signal having an output dispersion profile, the output dispersion profile being different from the input dispersion profile.

29. The method of claim 28, wherein the light signal portions are combined such that the output light signal has a dispersion profile that is narrower than the dispersion profile of the input light signal.

30. The method of claim 28, wherein the light signal portions are combined such that the output light signal has a dispersion profile that is broader than the dispersion profile of the input light signal.

31. The method of claim 28, wherein the light signal portions are combined such that the output light signal has a dispersion profile with positive dispersion slope relative to the dispersion profile of the input light signal.

32. The method of claim 28, wherein the light signal portions are combined such that the output light signal has a dispersion profile with negative dispersion slope relative to the dispersion profile of the input light signal.

33. The method of claim 28, wherein the light signal portions are combined in a light distribution component having an input side and an output side, the light signal portions combined such that input light signals having different wavelengths are directed to different locations on an output side of the light distribution component.
